(19) United States
(12) Patent Application Publication
(10) Pub. No.: US 2013/0050138 A1
(43) Pub. Date: Feb. 28, 2013

(54) SENSING APPARATUS AND SENSING METHOD

(71) Applicants: Isaac Wing-Tak Chan, Hsinchu City (TW); Chen-Wei Lin, Kaohsiung City (TW); Chih-Chieh Hsu, Hsinchu City (TW)

(72) Inventors: Isaac Wing-Tak Chan, Hsinchu City (TW); Chen-Wei Lin, Kaohsiung City (TW); Chih-Chieh Hsu, Hsinchu City (TW)

(73) Assignee: INDUSTRIAL TECHNOLOGY RESEARCH INSTITUTE, Hsinchu (TW)

(21) Appl. No.: 13/348,609

(22) Filed: Jan. 11, 2012

(30) Foreign Application Priority Data
Aug. 22, 2011 (TW) 100129954

(51) Int. Cl. G06F 3/044

(52) U.S. Cl. 345/174; 178/18.06

(57) ABSTRACT

A sensing device including first and second scan lines, a readout line, first and second sensing units is provided. The first sensing unit is coupled to the first scan line, the second scan line, and the readout line and configured to sense a first energy. The first sensing unit outputs a first readout signal corresponding to the first energy to the readout line in response to a first scan signal on the first scan line. The second sensing unit is coupled to the second scan line and the readout line and configured to sense a second energy. The second sensing unit outputs a second readout signal corresponding to the second energy to the readout line in response to a second scan signal on the second scan line. The second scan signal works in cooperation with the first scan signal to reset the first sensing unit.

### CROSS-REFERENCE TO RELATED APPLICATION

This application claims the priority benefit of Taiwan application serial no. 100129954, filed on Aug. 22, 2011. The entirety of the above-mentioned patent application is hereby incorporated by reference herein and made a part of this specification.

### BACKGROUND

1. Technical Field

The disclosure relates to a sensing apparatus and a sensing method.

2. Related Art

With development of sensing techniques, flat-type sensing unit arrays have been widely applied in various domains, for example, applied in optical image sensors, digital radiography sensors (DRS) and touch screen sensors, etc. A structure of a main device (an active array substrate) of the flat-type sensing unit array is similar to a substrate in a flat panel display, for example, similar to a thin-film transistor array substrate in a thin film transistor liquid crystal display (TFT-LCD).

In order to further improve a sensing effect, the current sensing technique is developed towards a trend of large area sensing, improvement of a low-energy sensing capability and high resolution. However, enhancement of the resolution may reduce a pixel area of a sensor, and accordingly reduce sensitivity of the sensor for sensing an incident energy. Moreover, low incident energy may result in a low strength of an electric signal converted from the energy by the sensor. Moreover, the large area sensing is liable to generate noises due to resistance and capacitance (RC) coupling of the sensor.

Generally, one pixel on the conventional active array substrate only contains a single thin film transistor to serve as a switch for read and reset operations, and such structure cannot achieve signal gain to mitigate the noise problem. A conventional design that has a pixel amplifier can only resolve a part of the aforementioned problems, and cannot resolve all of the aforementioned problems.

### SUMMARY

An embodiment of the disclosure provides a sensing apparatus including a first scan line, a second scan line, a readout line, a first sensing unit, and a second sensing unit. The first sensing unit is coupled to the first scan line, the second scan line, and the readout line and is configured to sense a first energy. The first sensing unit outputs a first readout signal corresponding to the first energy to the readout line in response to a first scan signal on the first scan line. The second sensing unit is coupled to the second scan line and the readout line and is configured to sense a second energy. The second sensing unit outputs a second readout signal corresponding to the second energy to the readout line in response to a second scan signal on the second scan line. The second scan signal works in cooperation with the first scan signal to reset the first sensing unit.

Another embodiment of the disclosure provides a sensing method including following steps. A first sensing unit and a second sensing unit are provided to respectively sense a first energy and a second energy. The first sensing unit outputs a first readout signal corresponding to the first energy in response to a first scan signal. The second sensing unit outputs a second readout signal corresponding to the second energy in response to a second scan signal. The second scan signal works in cooperation with the first scan signal to reset the first sensing unit.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a circuit schematic diagram of a sensing apparatus according to an exemplary embodiment.

FIG. 2 is a waveform diagram of the sensing apparatus of FIG. 1.

FIG. 3 shows an example of the sensing device in FIG. 1.

FIG. 4 is a partial circuit diagram of the interpretation unit of FIG. 1.

FIG. 5 is a flowchart illustrating a sensing method according to an exemplary embodiment.

### DETAILED DESCRIPTION OF DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

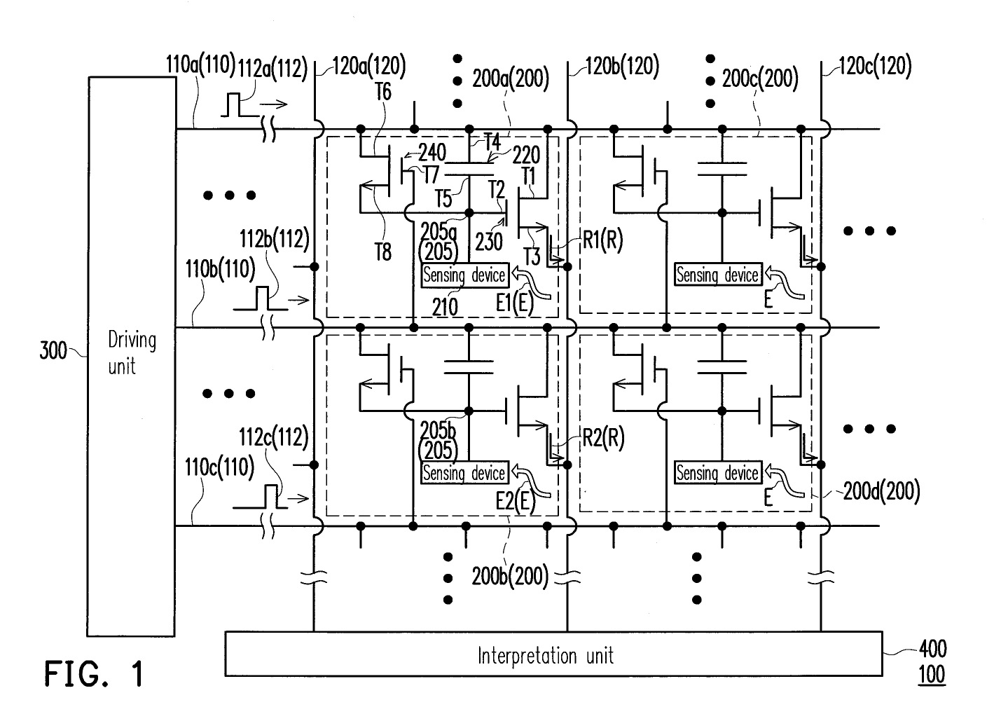

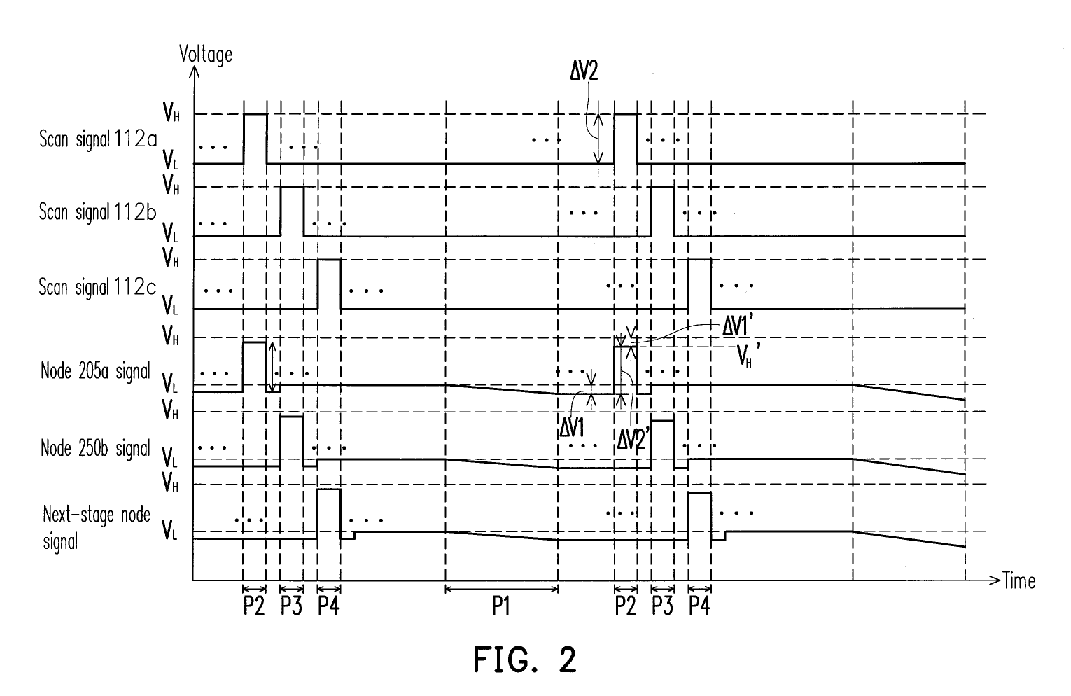

FIG. 1 is a circuit schematic diagram of a sensing apparatus according to an exemplary embodiment, and FIG. 2 is a waveform diagram of the sensing apparatus of FIG. 1. Referring to FIG. 1 and FIG. 2, the sensing apparatus 100 of the embodiment includes a plurality of scan lines 110, a plurality of readout lines 120 and a plurality of sensing units 200. In FIG. 1, three scan lines 110a, 110b and 110c, three readout lines 120a, 120b and 120c, and four sensing units 200a, 200b, 200c and 200d are schematically illustrated for example, and in the present embodiment, circuit structures of the sensing units 200, the scan lines 110 and the readout lines 120 can repeatedly appear at top, bottom, left and right of FIG. 1. For example, regarding the scan lines 110, a first scan line 110, a second scan line 110, . . . , a K^{th} scan line 110 are sequentially arranged from the top to the bottom in FIG. 1, where K is a positive integer greater than or equal to 3. Scan lines 110a, 110b and 110c shown in FIG. 1 are respectively an Nth scan line 110, an (N+1)^{th} scan line 110 and an (N+2)^{th} scan line 110, where N is a positive integer smaller than or equal to K−2. Regarding the readout lines 120, a first readout line to a J^{th} readout line are sequentially arranged from the left to the right in FIG. 1, where J is a positive integer greater than or equal to 2. Readout lines 120a, 120b and 120c shown in FIG. 1 are respectively an (M−1)^{th} readout line 120, an Mth readout line 120 and an (M+1)^{th} readout line 120, where M is a positive integer smaller than or equal to J−1. When J=2, the readout line 120a can be removed. Each of the sensing units 200 is coupled to two adjacent scan lines 110, and is coupled to one adjacent readout line 120. For example, the sensing unit 200a is coupled to the scan line 110a, the scan line 110b and the readout line 120b, and the sensing unit 200b is coupled to the scan line 110b, the scan line 110c and the readout line 120b. Moreover, each of the sensing units 200 is configured to sense an energy E exerted thereon. For example, the sensing unit 200a is configured to sense an energy E1, and the sensing unit 200b is configured to sense an energy E2.

The sensing unit 200a outputs a readout signal R1 corresponding to the energy E1 to the readout line 120b in response to a scan signal 112a on the scan line 110a. The sensing unit 200b outputs a readout signal R2 corresponding to the energy E2 to the readout line 120b in response to a scan signal 112b on the scan line 110b. Moreover, the scan signal 112b works in cooperation with the scan signal 112a to reset the sensing unit 200a. Moreover, a scan signal 112c on the scan line 110c works in cooperation with the scan signal 112b to reset the sensing unit 200b.

In present embodiment, each of the sensing units 200 (for example, the sensing unit 200a, 200b, 200c or 200d) includes a sensing device 210, a storage device 220, an amplification device 230 and a reset device 240. The sensing device 210 senses the energy E, and converts the sensed energy E into a data signal. The storage device 220 is coupled to the adjacent scan line 110 and the sensing device 210, and is configured to store the data signal. For example, the sensing device 210 of the sensing unit 200a senses the energy E1, and converts the sensed energy E1 into a data signal, and the storage device 220 of the sensing unit 200a is coupled to the scan line 110a and the sensing device 210 of the sensing unit 200a, and is configured to store the data signal converted from the energy E1.

The amplification device 230 is coupled to the storage device 220, the adjacent scan line 110 and the adjacent readout line 120, where the amplification device 230 outputs the readout signal R corresponding to the data signal to the readout line 120 in response to the scan signal 112 on the adjacent scan line 110. Moreover, the reset device 240 is coupled to the storage device 220, the aforementioned adjacent scan line 110 and another adjacent scan line 110 (i.e. a next-stage scan line 110), and the reset device 240 resets the storage device 220 in response to the scan signal 112 on the adjacent scan line 110 (for example, the scan line 110 on the top of the reset device 240 in FIG. 1) and the scan signal 112 on the other adjacent scan line 110 (i.e. the next-stage scan line 110, for example, the scan line 110 at the bottom of the reset device 240 in FIG. 1).

For example, the amplification device 230 of the sensing unit 200a is coupled to the storage device 220 of the sensing unit 200a, the scan line 110a and the readout line 120b, where the amplification device 230 of the sensing unit 200a outputs the readout signal R corresponding to the data signal stored in the storage device 220 of the sensing unit 200a to the readout line 120b in response to the scan signal 112a on the scan line 110a. Moreover, the reset device 240 of the sensing unit 200a is coupled to the storage device 220 of the sensing unit 200a, the scan line 110a and the scan line 110b, and the reset device 240 of the sensing unit 200a resets the storage device 220 of the sensing unit 200a in response to the scan signal 112b on the scan line 110b and the scan signal 112a on the scan line 110a.

In the present embodiment, in each of the sensing units 200, the energy E is light energy or electromagnetic energy, and the sensing device 210 is an electromagnetic sensing device, for example, a photodiode. However, in another embodiment, the electromagnetic sensing device can also be a photoresistor, a photoconductor, a phototransistor, or other suitable electromagnetic sensing devices. Moreover, in other embodiments, the energy E can also be a mechanical energy, for example, an elastic potential energy, or a kinetic energy, etc., and the sensing device 210 is, for example, a pressure sensing device. The pressure sensing device is, for example, a piezoelectric sensor or other suitable pressure sensing devices. In addition, the energy E can also be thermal energy, and the sensing device 210 is, for example, a temperature sensing device. Moreover, the energy E can also be electric energy, and the sensing device 210 is, for example, a touch sensing device for sensing capacitance variation caused by a touch operation of a finger or other objects. In the other embodiments, the energy E can also be other types of energy that can be detected, and the sensing device 210 is a corresponding sensor for detecting such energy.

In the present embodiment, a current input terminal T1 of the amplification device 230 of the sensing unit 200a is coupled to the scan line 110a and a first terminal T4 of the storage device 220 of the sensing unit 200a, a control terminal T2 of the amplification device 230 of the sensing unit 200a is coupled to a second terminal T5 of the storage device 220 of the sensing unit 200a, and a current output terminal T3 of the amplification device 230 of the sensing unit 200a is coupled to the readout line 120b. The amplification device 230 is, for example, a transistor. In the present embodiment, the amplification device 230 in each of the sensing units 200 is, for example, a field effect transistor, and the current input terminal T1, the control terminal T2 and the current output terminal T3 are, for example, respectively a source, a gate and a drain of the field effect transistor. However, in other embodiments, the amplification device 230 can also be a bipolar transistor or other transistors. In the present embodiment, the storage device 220 of each of the sensing units 200 is, for example, a capacitor, and a capacitance of the capacitor is far greater than a parasitic capacitance (typically about or more than 0.055 pF) between the current input terminal T1 and the control terminal T2 of the amplification device 230. In an embodiment, the capacitance of the capacitor is greater than or equal to 0.55 pF, or the capacitance of the capacitor is greater than or equal to 10 times of the parasitic capacitance between the current input terminal T1 and the control terminal T2 of the amplification device 230.

In the present embodiment, a first terminal T6 of the reset device 240 of the sensing unit 200a is coupled to the scan line 110a, a control terminal T7 of the reset device 240 of the sensing unit 200a is coupled to the scan line 110b, and a second terminal T8 of the reset device 240 of the sensing unit 200a is coupled to the control terminal T2 of the amplification device 230 of the sensing unit 200a. In the present embodiment, the reset device 240 in each of the sensing units 200 is, for example, a field effect transistor, and the first terminal T6, the control terminal T7 and the second terminal T8 thereof are, for example, respectively a source, a gate and a drain of the field effect transistor. However, in other embodiments, the reset device 240 can also be a bipolar transistor, other transistors or other switch devices.

In the present embodiment, the sensing device 210 of the sensing unit 200b senses the energy E2, and converts the sensed energy E2 into a data signal. The storage device 220 of the sensing unit 200b is coupled to the scan line 110b and the sensing device 210 of the sensing unit 200b, and is configured to store the data signal converted from the energy E2. The amplification device 230 of the sensing unit 200b is coupled to the storage device 220 of the sensing unit 200b, the scan line 110b and the readout line 120b, where the amplification device 230 outputs a readout signal R2 corresponding to the data signal converted from the energy E2 to the readout line 120b in response to the scan signal 112b on the scan line 110b.

Moreover, in this embodiment, the reset device 240 of the sensing unit 200b is coupled to the storage device 220 of the sensing unit 200b, the scan line 110b and the scan line 110c, and the reset device 240 of the sensing unit 200b resets the storage device 220 of the sensing unit 200b in response to a scan signal 112c on the scan line 110c and the scan signal 112b on the scan line 110b.

In detail, in the present embodiment, the current input terminal T1 of the amplification device 230 of the sensing unit 200b is coupled to the scan line 110b and the first terminal T4 of the storage device 220 of the sensing unit 200b, the control terminal T2 of the amplification device 230 of the sensing unit 200b is coupled to the second terminal T5 of the storage device 220 of the sensing unit 200b, and the current output terminal T3 of the amplification device 230 of the sensing unit 200b is coupled to the readout line 120b. Moreover, the first terminal T6 of the reset device 240 of the sensing unit 200b is coupled to the scan line 110b, the control terminal T7 of the reset device 240 of the sensing unit 200b is coupled to the scan line 110c, and the second terminal T8 of the reset device 240 of the sensing unit 200b is coupled to the control terminal T2 of the amplification device 230 of the sensing unit 200b.

In the present embodiment, the scan signals 112 sequentially enable the sensing units 200. For example, the scan signal 112a, the scan signal 112b and the scan signal 112c sequentially enable the sensing unit 200a, the sensing unit 200b and a next-stage sensing unit of the sensing unit 200b (not shown). In the present embodiment, the scan signals 112 are sent from a driving unit 300, and the driving unit 300 is electrically connected to the scan lines 110. The driving unit 300 is, for example, a driving circuit.

In the present embodiment, when the scan signal 112 of a scan line 110 has a high voltage level V_{H}, the scan signal 112 causes conduction between the first terminal T6 and the second terminal T8 of the reset device 240 in the previous-stage sensing unit 200 relative to the scan line 110, and now the scan signal 112 of the previous-stage scan line 110 has a low voltage level V_{L}, so that the first terminal T4 and the second terminal T5 of the storage device 220 of the previous-stage sensing unit 200 are all in the low voltage level V_{L} to reset the storage device 220. For example, in a time period P3 of FIG. 2, the scan signal 112a on the scan line 110a has the low voltage level V_{L}, and the scan signal 112b on the scan line 110b has the high voltage level V_{H}, and now the scan signal 112b is transmitted to the control terminal T7 of the reset device 240 to turn on the reset device 240, so that a node 205a has a voltage level the same as the low voltage level V_{L} of the scan signal 112a. In this way, the scan line 110a and the node 205a are all in the low voltage level V_{L}, and the storage device 220 substantially has no charge accumulation, so as to achieve an effect that the scan signal 112b works in cooperation with the scan signal 112a to reset the storage device 220. Now, the control terminal T2 of the amplification device 230 is also in the low voltage level V_{L}, so that the amplification device 230 is turned off, and the current output terminal T3 of the amplification device 230 does not output a current signal to the readout line 120b.

After the time period P3, for example, in a time period P4, the scan signal 112a and the scan signal 112b are all in the low voltage level V_{L}, so that the reset device 240 is turned off. Now, the node 205a is still maintained to a final state as that in the time period P3, i.e. the low voltage level V_{L}.

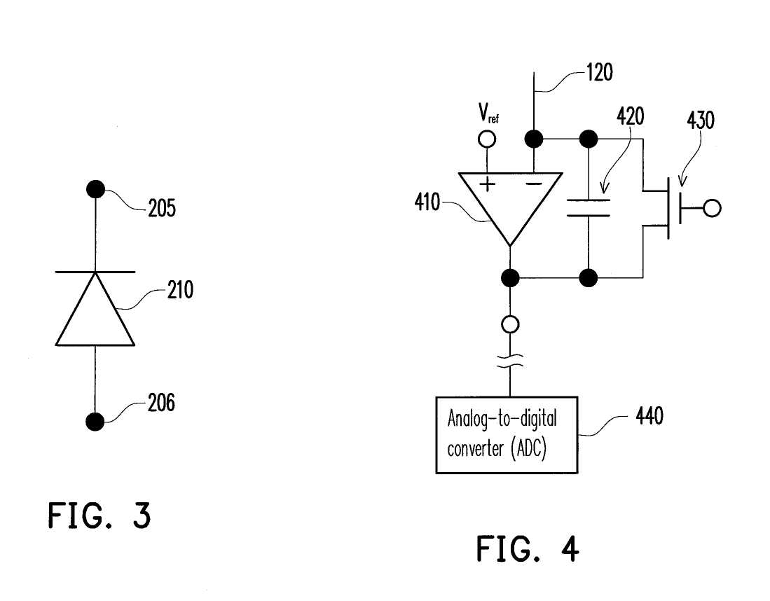

FIG. 3 shows an example of the sensing device in FIG. 1. Referring to FIG. 1 to FIG. 3, the sensing device 210 in FIG. 3 is, for example, a photodiode. An N-pole of the photodiode is coupled to the node 205, where the node 205 is coupled between the second terminal T8 of the reset device 240 and the control terminal T2 of the amplification device 230, and is coupled between the second terminal T5 of the storage device 220 and the N-pole of the photodiode. Moreover, a P-pole of the photodiode is coupled to a terminal 206. In a time period P1 after the time period P4 in FIG. 2, a negative voltage is applied on the terminal 206. Now, the scan signal 112a on the scan line 110a and the scan signal 112b on the scan line 110b are all in the low voltage level V_{L}, so that the node 205a is still in the low voltage level V_{L}. Therefore, the sensing device 210 (i.e. the photodiode) of the sensing unit 200a withstands a reverse bias. Now, when light irradiates the sensing device 210 of the sensing unit 200a (i.e. the sensing device 210 receives the energy E), a reverse current flowing through the sensing device 210 is generated, i.e. a current flowing from the node 205 (i.e. the node 205a) to the terminal 206, so that the charges are accumulated on the storage device 220 of the sensing unit 200a. In other words, the time period P1 is a sensing time period of the sensing unit 200. In this way, a voltage difference ΔV1 is formed between the second terminal T5 and the first terminal T4 of the storage device 220 of the sensing unit 200a. Since now the scan line 110a is still maintained to the low voltage level V_{L}, when the time period P1 is ended, the voltage of the node 205a is maintained to V_{L}+ΔV1. In the present embodiment, the voltage difference ΔV1, for example, has a negative value.

In a time period P2 after the time period P1, the scan signal 112a of the scan line 110a is in the high voltage level V_{H}, and the scan signal 112b of the scan line 110b is in the low voltage level V_{L}. Now, the scan signal 112b makes the control terminal T7 of the reset device 240 of the sensing unit 200a be in the low voltage level V_{L}, so that the reset device 240 is turned off On the other hand, the scan signal 112a pulls up the voltage level of the node 205a to a voltage level V_{H}′ slightly lower than the high voltage level V_{H} through a capacitance coupling effect of the storage device 220 of the sensing unit 200a. In an ideal state, according to the capacitance coupling effect, a voltage variation ΔV2 of the scan signal 112a increased from the low voltage level V_{L} to the high voltage level V_{H} is substantially equal to a voltage variation ΔV2′ of the node 205a increased from the voltage level V_{L}+ΔV1 to the voltage level V_{H}′. However, in an actual application, the voltage variation ΔV2′ is slightly less than the voltage variation ΔV2, and a relationship of the voltage variation ΔV2′ and the voltage variation ΔV2 is, for example, as follows.

$$Δ {V}_{2}^{′} = K \frac{{C}_{st}}{{C}_{st} + {C}_{g}} Δ {V}_{2}$$

where Cₛₜ is a capacitance of the storage device 220, C_{g} is a gate capacitance of the amplification device 230 (including a capacitance Cₒₓ of a gate oxide layer or an insulation layer, a parasitic capacitance C_{gs} from the gate to the source, and a parasitic capacitance C_{gd} from the gate to the drain), K is a unitless constant, which is used for representing other coupling loss, where K≦1, and K=1 represents no coupling loss.

In the ideal state, since the voltage variation ΔV2′ is substantially equal to the voltage variation ΔV2, a voltage difference ΔV1′ of the voltage level V_{H}′ and the high voltage level V_{H} is substantially equal to the voltage difference ΔV1. However, in an actual application, an absolute value of the voltage difference ΔV1′ is slightly greater than an absolute value of the voltage difference ΔV1, and a relationship therebetween can be deduced from the above relationship of the voltage variation ΔV2′ and the voltage variation ΔV2.

When the sensing device 210 of the sensing unit 200a does not sense the energy E during the time period P1, the current flowing through the sensing device 210 is not generated, and no charge is accumulated on the storage device 220. In other words, a cross voltage of the storage device 220 is 0, i.e. the voltage level of the node 205a is now in the low voltage level V_{L}. Therefore, in the time period P2 after the time period P1, in the ideal state, since the scan signal 112a is in the high voltage level V_{H}, the node 205a is also in the high voltage level V_{H} through the capacitance coupling effect of the storage device 220. Now, due to the amplification effect of the amplification device 230 of the sensing unit 200a, the high voltage level V_{H} of the node 205a is converted into a current I flowing from the current input terminal T1 to the current output terminal T3 of the amplification device 230. However, when the sensing device 210 of the sensing unit 200a senses the energy E during the time period P1, different magnitudes of the sensed energy E may produce different voltage differences ΔV1 at the two ends of the storage device 220 of the sensing unit 200a.

Therefore, in the time period P2 after the time period P1, different voltage differences ΔV1′ are produced. Due to the amplification effect of the amplification device 230 of the sensing unit 200a, the voltage level V_{H}+ΔV1′ of the node 205a is converted into a current I+ΔI flowing from the current input terminal T1 to the current output terminal T3 of the amplification device 230, where a value of ΔI corresponds to a value of ΔV1′, so that different voltage differences ΔV1′ correspond to different current differences ΔI.

The current I or the current I+ΔI flows to the readout line 120b during the time period P2, and then flows to an interpretation unit 400. The interpretation unit 400 is electrically connected to the readout lines 120 to interpret the current signals (i.e. the readout signals R) received from the readout lines 120. When the current from the readout line 120 is the current I, the interpretation unit 400 determines that the sensing device 210 of the sensing unit 200 that outputs such current does not sense the energy E. When the current from the readout line 120 is the current I+ΔI, the interpretation unit 400 determines a magnitude of the energy E sensed by the sensing device 210 of the sensing unit 200 that outputs such current according to an absolute value of ΔI, where the greater the absolute value of ΔI is, the greater the energy E sensed by the sensing device 210 is. Since the scan signals 112 of the scan lines 110 sequentially enable the sensing units 200, the sensing units 200 of different rows (for example, the sensing unit 200a and the sensing unit 200b) sequentially output the current signals to the interpretation unit 400. Therefore, the interpretation unit 400 can determine from which row of the sensing units 200 the current signals are according to a receiving time of the current signals. On the other hand, the sensing units 200 in the same row (for example, the sensing unit 200a and the sensing unit 200c) are simultaneously driven by the scan signal 112 of the same scan line 110, and the sensing units 200 in the same row simultaneously output the current signals to the different readout lines 120. Therefore, the interpretation unit 400 can determine from which column of the sensing units 200 the current signal is according to which of the readout lines 120 the current signal is from. Therefore, one sensing unit 200 can be regarded as a pixel, and after passing through the time period P1, the time period P2, the time period P3 and the time period P4, or further after passing through an enable time of the other scan signals 112 between the time period P1 and the time period P2 and an enable time of the other scan signals 112 between the time period P4 and a next time period P1, the sensing apparatus 100 can extract an image of one frame. Moreover, as the above time periods repeatedly appear, the sensing apparatus 100 can extract a plurality of frames, so as to obtain dynamic images.

The other detailed operation of the sensing unit 200b can refer to the aforementioned descriptions of the operation of the sensing unit 200a, the operation performed by the sensing unit 200a after receiving the scan signal 112a is equivalent to the operation performed by the sensing unit 200b after receiving the scan signal 112b, and the operation performed by the sensing unit 200a after receiving the scan signal 112b is equivalent to the operation performed by the sensing unit 200b after receiving the scan signal 112c. The signal on the node 205b of the sensing unit 200b and the signal on the node 205 of the next-stage sensing unit 200 are as that shown in FIG. 2. Therefore, besides a readout time of the sensing unit 200a (i.e. a time for outputting the readout signal R1), the time period P2 is also a reset time of the previous-stage sensing unit 200. Besides a readout time of the sensing unit 200b (i.e. a time for outputting the readout signal R2), the time period P3 is also a reset time of the sensing unit 200a. Besides the reset time of the sensing unit 200b, the time period P4 is also a readout time of a next-stage sensing unit 200. Other details can be deduced according to the descriptions of the sensing unit 200a, which are not repeated.

Circuit structures and operation of the sensing unit 200c, the sensing unit 200d and the other sensing units 200 can be deduced according to the circuit structures and the operation of the sensing unit 200a and the sensing unit 200b, which are not repeated herein.

Moreover, in the above embodiment, the sensing device 210 being a photo detector is taken as an example for descriptions, and the detected energy E is, for example, light energy or electromagnetic energy, though the disclosure is not limited thereto. Moreover, the voltage difference ΔV1 and the current difference ΔI are not limited to be negative values, and when different sensing devices 210 are used or different configuration methods are applied, the voltage difference ΔV1 and the current difference ΔI can also be positive values or negative values.

FIG. 4 is a partial circuit diagram of the interpretation unit of FIG. 1. Referring to FIG. 1, FIG. 2 and FIG. 4, in the embodiment, the interpretation unit 400 includes a plurality of operational amplifiers 410, a plurality of capacitors 420, a plurality of switch devices 430 and a plurality of analog-to-digital converters (ADC) 440. Each of the readout lines 120 is coupled to an inverted input terminal of an operation amplifier 410, and a non-inverted input terminal of the operation amplifier 410 receives a reference voltage V_{ref}. Moreover, two ends of the capacitor 420 are respectively coupled to the inverted input terminal and an output terminal of the operation amplifier 410. Moreover, two terminals (for example, a source and a drain) of the switch device 430 (for example, a transistor) are respectively coupled to the two ends of the capacitor 420. In addition, the output terminal of the operation amplifier 410 is coupled to the ADC 440. The operation amplifier 410 and the capacitor 420 convert the current signal from the readout line 120 into a voltage signal through charges accumulated on the capacitor 420, and the ADC 440 converts the analog voltage signal into a digital voltage signal. Moreover, the switch device 430 is configured to reset the capacitor 420. Each time before an enable time of a next scan signal starts (for example, before the time period P2, the time period P3, and the time period P4 start), the switch device 430 is turned on to short-circuit the two ends of the capacitor 420, so as to discharge the charges on the capacitor 420 to reset the capacitor 420. Then, the switch device 430 is turned off, so that the operation amplifier 410 and the capacitor 420 can convert a current signal into a voltage signal during the enable time of the next scan signal.

It should be noticed that the circuit design of the interpretation unit 400 is not limited to that of FIG. 4, and other circuit structures can also be used as long as a magnitude of ΔI can be determined.

In the present embodiment, a voltage gain from a voltage signal of the node 205 to the voltage signal output by the operation amplifier 410 can be calculated according to the following equations:

When the amplification device 230 is a metal oxide semiconductor field effect transistor, a following equation is obtained:

$${I}_{amp} = \frac{1}{2} \frac{W}{L} μ {C ( {V}_{amp} - {V}_{T} )}^{2} \qquad ( 1 )$$

where Vₐₘₚ is a voltage of the node 205, V_{T} is a threshold voltage of the transistor, C is a unit capacitance of a gate oxide layer of the transistor, μ is a carrier mobility, W is a gate width of the transistor, L is a gate length of the transistor, and Iₐₘₚ is a current flowing from the source to the drain of the transistor. The equation (1) is partially differentiated with respect to Vₐₘₚ to obtain a transconductance gₘ:

$${g}_{m} = \frac{\partial {I}_{amp}}{\partial {V}_{amp}} = \frac{W}{L} μ C ( {V}_{amp} - {V}_{T} ) \qquad ( 2 )$$

Moreover, an equation of the capacitor 420 is:

$${C}_{f} = \frac{{Q}_{f}}{{V}_{out}} = \frac{{I}_{amp} {T}_{s}}{{V}_{out}} \qquad ( 3 )$$

where C_{f} is a capacitance of the capacitor 420, Vₒᵤₜ represents a voltage output from the output terminal of the operation amplifier 410, Q_{f} represents charges accumulated on the capacitor 420 between two adjacent reset time periods, and Tₛ is a charging time of the capacitor 420 between two adjacent reset time periods.

A voltage gain A_{V} from the node 205 to the output terminal of the operation amplifier 410 is:

$${A}_{V} = \frac{Δ {V}_{out}}{Δ {V}_{amp}} = \frac{{V}_{out 2} - {V}_{out 1}}{{V}_{amp 2} - {V}_{amp 1}} = \frac{{g}_{m} {T}_{s}}{{C}_{f}} \qquad ( 4 )$$

where Vₐₘₚ₁ and Vₐₘₚ₂ are two different voltages on the node 205, which respectively produce voltages Vₒᵤₜ₁ and Vₒᵤₜ₂, where ΔVₐₘₚ=Vₐₘₚ₂−Vₐₘₚ₁, and ΔVₒᵤₜ=Vₒᵤₜ₂−Vₒᵤₜ₁. By substituting gₘ of the equation (4) with a rightmost part of the equation (2), substituting C_{f} of the equation (4) with a rightmost part of the equation (3), and substituting Iₐₘₚ therein with a right part of the equation (1), an equation (5) is obtained:

$${A}_{V} = \frac{2 {V}_{out}}{{V}_{amp} - {V}_{T}} \qquad ( 5 )$$

Therefore, the voltage gain A_{V} can be calculated according to the equation (5).

Parameters of the sensing apparatus 100 are provided below for an example, though the disclosure is not limited thereto.

In an embodiment, A_{V}≧5, ΔA_{V}≦10%, and now Vₒᵤₜ₁=10 V, ΔVₒᵤₜ=2 V, C_{f}=1 pF, and parameters of the transistor are: μ=0.5 cm²/Vs, V_{T}=2V, C=20 nF/cm², and W/L=10. In detail, in an embodiment, the parameters are listed in a following table:

| | | |
|---|---|---|
| Vₐₘₚ₁ − V_{T} = 3.6 V | Vₐₘₚ₂ − V_{T} = 3.24 V | ΔVₐₘₚ = 0.36 V |
| Vₒᵤₜ₁ = 10 V | Vₒᵤₜ₂ = 8.1 V | ΔVₒᵤₜ = 1.9 V |
| | Tₛ = 15.4 μs | Aᵥ ≈ 5.3 |

Namely, in the present embodiment, the voltage gain A_{V} is about 5.3. Therefore, the sensing apparatus 100 of the embodiment has a higher voltage gain.

In the sensing apparatus 100 of the embodiment, since the current I or I+ΔI of the amplification device 230 is provided by the scan signal 112 of the scan line 110, the sensing apparatus 100 does not require an extra bias line to exert a bias to the amplification device 230. Moreover, in the present embodiment, since resetting of the sensing unit 200 is implemented through cooperation of the scan signals 112 of two adjacent scan lines 110, the sensing apparatus 100 does not require an extra reset line to reset the sensing unit 200. Since the bias line and the reset line are not used, a fine structure of the sensing units 200, the scan lines 110 and the readout lines 120 can be designed. Alternatively, from another point of view, as the bias line and the reset line are not used, a fill factor of the sensing unit 200 can be improved, i.e. an area ratio of the sensing device 210 is increased, so as to improve sensitivity (for example, light sensitivity) of the sensing apparatus 100. When the sensing apparatus 100 serves as a radiography sensor, since the sensing apparatus 100 has high sensitivity, when an examinee takes an X-ray inspection, a radiation amount from the X-ray source can be reduced, so that an X-ray exposure amount of the examinee is reduced to protect the examinee. Moreover, when the sensing apparatus 100 serves as an image sensing apparatus, since the sensing apparatus 100 has the high sensitivity, it can still effectively detect an object image under a weak ambient light environment.

Moreover, in the embodiment, after the storage device 220 is reset, the current input terminal T1 and the control terminal T2 of the corresponding amplification device 230 are all in the low voltage level V_{L}, so that a cross voltage of the current input terminal T1 and the control terminal T2 and a cross voltage of the current input terminal T1 and the current output terminal T3 of the amplification device 230 are very small (for example, close to 0). In this way, a threshold voltage of the amplification device 230 is stable, and a leakage current of the amplification device 230 in a turn-off state is effectively suppressed. Therefore, the sensing apparatus 100 of the embodiment can effectively reduce noises. Moreover, according to the aforementioned analysis and experiment data, it is known that based on the amplification effect of the amplification device 230, the sensing apparatus 100 of the embodiment has the relatively large voltage gain A_{V}, so that the sensitivity of the sensing apparatus 100 is further improved.

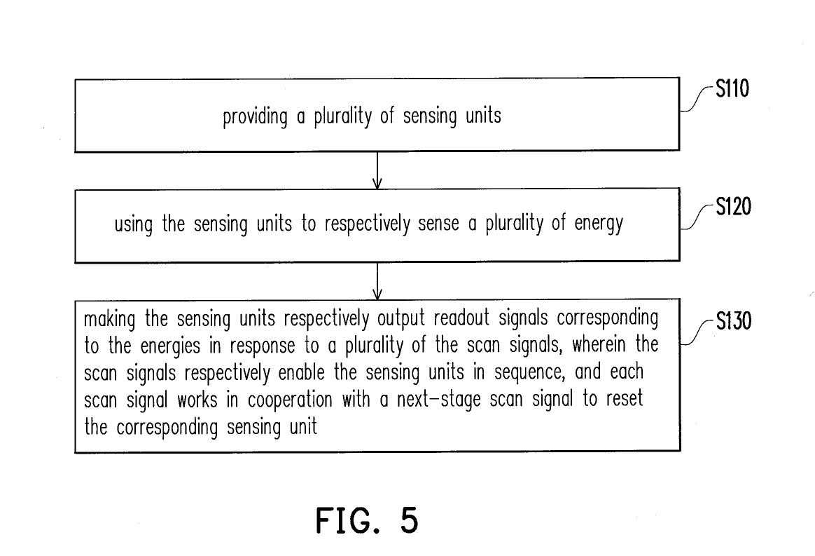

FIG. 5 is a flowchart illustrating a sensing method according to an embodiment. Referring to FIG. 1, FIG. 2 and FIG. 5, the sensing method of the present embodiment can be implemented by the sensing apparatus 100 of FIG. 1. The sensing method of the embodiment includes following steps. First, in step S110, a plurality of sensing units 200 is provided. For example, the sensing units 200a, 200b, 200c and 200d and other sensing units 200 are provided. Then, in step S120, the sensing units 200 are configured to respectively sense a plurality of energy E. For example, the sensing unit 200a and the sensing unit 200b can be configured to respectively sense the energy E1 and the energy E2. Then, in step S130, the sensing units 200 respectively output readout signals corresponding to the energies E in response to a plurality of the scan signals 112. In the present embodiment, the scan signals 112 sequentially enable the sensing units 200, and each scan signal 112 works in cooperation with a next-stage scan signal 112 to reset the corresponding sensing unit 200. For example, the sensing unit 200a outputs the readout signal R1 corresponding to the energy E1 in response to the scan signal 112a, and the sensing unit 200b outputs the readout signal R2 corresponding to the energy E2 in response to the scan signal 112b. The scan signal 112a and the scan signal 112b sequentially enable the sensing unit 200a and the sensing unit 200b, and the scan signal 112b works in cooperation with the scan signal 112a to reset the sensing unit 200a.

The aforementioned step that the sensing unit 200a outputs the readout signal R1 corresponding to the energy E1 in response to the scan signal 112a includes following steps. First, the sensed energy E1 is converted into a data signal. Then, the data signal is stored, for example, the storage device 220 of the sensing unit 200a is configured to store the data signal, i.e. the data signal is stored in form of the voltage difference ΔV1. The readout signal R1 corresponding to the data signal is output in response to the scan signal 112a, which is, for example, implemented through the amplification device 230 of the sensing unit 200a.

Similarly, the aforementioned step that the sensing unit 200b outputs the readout signal R2 corresponding to the energy E2 in response to the scan signal 112b includes following steps. First, the sensed energy E2 is converted into a data signal. Then, the data signal is stored, for example, the storage device 220 of the sensing unit 200b is configured to store the data signal, i.e. the data signal is stored in form of the voltage difference ΔV1. Then, the readout signal R2 corresponding to the data signal is output in response to the scan signal 112b, which is, for example, implemented through the amplification device 230 of the sensing unit 200b.

Moreover, the step that the scan signal 112b works in cooperation with the scan signal 112a to reset the sensing unit 200a includes a following step. When the scan signal 112a is in the low voltage level, the scan signal 112b is in the high voltage level, and the scan signal 112a is configured to reset the stored data signal through enabling of the scan signal 112b, for example, the scan signal 112b is enabled to turn on the reset device 240 of the sensing unit 200a, so as to reset the storage device 220 of the sensing unit 200a.

Similarly, the scan signal 112c can also work in cooperation with the scan signal 112b to reset the sensing unit 200c. Namely, when the scan signal 112b is in the low voltage level, the scan signal 112c is in the high voltage level, and the scan signal 112b is configured to reset the stored data signal through enabling of the scan signal 112c.

Other details of the sensing method of the embodiment can refer to related descriptions of the operations of the sensing apparatus 100 of FIG. 1, which are not repeated herein. Moreover, the step S120 and the step S130 of the sensing method of the embodiment can be repeatedly executed to achieve a real time sensing effect. For example, when the energy E is light energy or electromagnetic energy, and when the step S120 and the step S130 are executed for once, a static image can be captured according to the sensing method. Then, when the steps S120 and S130 are repeatedly executed, the sensing method can be used to capture dynamic images.

According to the sensing method of the embodiment, since the scan signals can be used to drive and reset the sensing units, and it is unnecessary to use an extra reset signal to reset the sensing units, the sensing method of the embodiment is relatively simple. Therefore, a circuit structure used for implementing the sensing method can be simplified to reduce cost. Moreover, when the sensing method is implemented by using the aforementioned sensing apparatus 100, the effects of the sensing apparatus 100 can also be achieved, which are not repeated herein.

In summary, in the sensing apparatus according to the embodiment of the disclosure, since the current of the amplification device is provided by the scan signal of the scan line, the sensing apparatus does not require an extra bias line to exert a bias to the amplification device. Moreover, in the embodiment of the disclosure, since resetting of the sensing unit is implemented through cooperation of the scan signals of two adjacent scan lines, the sensing apparatus does not require an extra reset line to reset the sensing unit. Since the bias line and the reset line are not used, a fine structure of the sensing units, the scan lines and the readout lines can be designed. Alternatively, from another point of view, as the bias line and the reset line are not used, a fill factor of the sensing unit can be improved, so as to improve sensitivity of the sensing apparatus.

Moreover, in the sensing apparatus according to the embodiment of the disclosure, after the storage device is reset, the current input terminal and the control terminal of the corresponding amplification device are all in the low voltage level, so that a cross voltage of the current input terminal and the control terminal and a cross voltage of the current input terminal and the current output terminal of the amplification device are very small. In this way, a threshold voltage of the amplification device is stable, and a leakage current of the amplification device in the turn-off state is effectively suppressed. Therefore, the sensing apparatus according to the embodiment of the disclosure can effectively reduce noises. Moreover, based on the amplification effect of the amplification device, the sensing apparatus of the embodiment has the relatively large voltage gain, so that the sensitivity of the sensing apparatus is further improved.

In addition, according to the sensing method in the embodiment of the disclosure, since the scan signals can be used to drive and reset the sensing units, and it is unnecessary to use an extra reset signal to reset the sensing units, the sensing method of the embodiment is relatively simple. Therefore, a circuit structure used for implementing the sensing method can be simplified to reduce cost.

It will be apparent to those skilled in the art that various modifications and variations can be made to the disclosed embodiments. It is intended that the specification and examples be considered as exemplary only, with a true scope of the disclosure being indicated by the following claims and their equivalents

What is claimed is:

1. A sensing apparatus, comprising:
a first scan line;
a second scan line;
a readout line;
a first sensing unit, coupled to the first scan line, the second scan line, and the readout line, and configured to sense a first energy, wherein the first sensing unit outputs a first readout signal corresponding to the first energy to the readout line in response to a first scan signal on the first scan line; and
a second sensing unit, coupled to the second scan line and the readout line, and configured to sense a second energy, wherein the second sensing unit outputs a second readout signal corresponding to the second energy to the readout line in response to a second scan signal on the second scan line, and the second scan signal works in cooperation with the first scan signal to reset the first sensing unit.

2. The sensing apparatus as claimed in claim 1, wherein the first scan signal and the second scan signal respectively enable the first sensing unit and the second sensing unit in sequence.

3. The sensing apparatus as claimed in claim 1, wherein the first sensing unit comprises:
a first sensing device, sensing the first energy, and converting the sensed first energy into a first data signal;
a first storage device, coupled to the first scan line and the first sensing device, and storing the first data signal;
a first amplification device, coupled to the first storage device, the first scan line and the readout line, wherein the first amplification device outputs the first readout signal corresponding to the first data signal to the readout line in response to the first scan signal on the first scan line; and
a reset device, coupled to the first storage device, the first scan line and the second scan line, wherein the reset device resets the first storage device in response to the second scan signal and the first scan signal.

4. The sensing apparatus as claimed in claim 3, wherein a current input terminal of the first amplification device is coupled to the first scan line and one end of the first storage device, a control terminal of the first amplification device is coupled to another end of the first storage device, and a current output terminal of the first amplification device is coupled to the readout line.

5. The sensing apparatus as claimed in claim 4, wherein a first terminal of the reset device is coupled to the first scan line, a control terminal of the reset device is coupled to the second scan line, and a second terminal of the reset device is coupled to the control terminal of the first amplification device.

6. The sensing apparatus as claimed in claim 5, wherein when the second scan signal is in a high voltage level, the second scan signal causes conduction between the first terminal and the second terminal of the reset device, and the first scan signal is in a low voltage level such that the end and the another end of the first storage device are all in the low voltage level, so as to reset the first storage device.

7. The sensing apparatus as claimed in claim 4, wherein the first storage device is a capacitor, and a capacitance of the capacitor is greater than or equal to 10 times of a parasitic capacitance between the current input terminal and the control terminal of the first amplification device.

8. The sensing apparatus as claimed in claim 3, wherein the first sensing device is an electromagnetic sensing device, a pressure sensing device, a temperature sensing device or a touch sensing device.

9. The sensing apparatus as claimed in claim 8, wherein the electromagnetic sensing device is a photodiode, a photoresistor, a photoconductor or a phototransistor.

10. The sensing apparatus as claimed in claim 3, wherein the first storage device is a capacitor, and a capacitance of the capacitor is greater than or equal to 0.55 pF.

11. The sensing apparatus as claimed in claim 1, wherein the second sensing unit comprises:
a second sensing device, sensing the second energy, and converting the sensed second energy into a second data signal;
a second storage device, coupled to the second scan line and the second sensing device, and storing the second data signal; and
a second amplification device, coupled to the second storage device, the second scan line and the readout line, wherein the second amplification device outputs the second readout signal corresponding to the second data signal to the readout line in response to the second scan signal on the second scan line.

12. The sensing apparatus as claimed in claim 11, wherein a current input terminal of the second amplification device is coupled to the second scan line and one end of the second storage device, a control terminal of the second amplification device is coupled to another end of the second storage device, and a current output terminal of the second amplification device is coupled to the readout line.

13. The sensing apparatus as claimed in claim 12, wherein the second storage device is a capacitor, and a capacitance of the capacitor is greater than or equal to 10 times of a parasitic capacitance between the current input terminal and the control terminal of the second amplification device.

14. The sensing apparatus as claimed in claim 11, wherein the second storage device is a capacitor, and a capacitance of the capacitor is greater than or equal to 0.55 pF.

15. The sensing apparatus as claimed in claim 1, wherein the first energy and the second energy are light energy, electromagnetic energy, mechanical energy, thermal energy or electric energy.

16. A sensing method, comprising:
providing a first sensing unit and a second sensing unit to respectively sense a first energy and a second energy;
making the first sensing unit output a first readout signal corresponding to the first energy in response to a first scan signal; and
making the second sensing unit output a second readout signal corresponding to the second energy in response to a second scan signal,
wherein the second scan signal works in cooperation with the first scan signal to reset the first sensing unit.

17. The sensing method as claimed in claim 16, wherein the first scan signal and the second scan signal respectively enable the first sensing unit and the second sensing unit in sequence.

18. The sensing method as claimed in claim 16, wherein the step of making the first sensing unit output the first readout signal corresponding to the first energy in response to the first scan signal comprises:
converting the sensed first energy into a first data signal;
storing the first data signal; and
outputting the first readout signal corresponding to the first data signal in response to the first scan signal.

19. The sensing method as claimed in claim 18, wherein the step that the second scan signal works in cooperation with the first scan signal to reset the first sensing unit comprises:
when the first scan signal is in a low voltage level, making the second scan signal be in a high voltage level, and using the first scan signal to reset the stored first data signal through enabling of the second scan signal.

20. The sensing method as claimed in claim 16, wherein the first energy and the second energy are light energy, electromagnetic energy, mechanical energy, thermal energy or electric energy.

21. The sensing method as claimed in claim 16, wherein the step of making the second sensing unit output the second readout signal corresponding to the second energy in response to the second scan signal comprises:
converting the sensed second energy into a second data signal;
storing the second data signal; and
outputting the second readout signal corresponding to the second data signal in response to the second scan signal.
